(19) United States
(12) Patent Application Publication
(10) Pub. No.: US 2015/0166419 A1
(43) Pub. Date: Jun. 18, 2015

(54) FORTIFIED HORTICULTURE GROWING MEDIUM

(71) Applicant: JIFFY INTERNATIONAL AS, Kristiansand (NO)

(72) Inventors: John K. WARD, Norwalk, OH (US); Jean-Marie BOUDREAU, Pokemouche, NB (CA); Zoel GAUTREAU, Tracadie-Sheila, NB (CA); Herald REIERSEN, Sofiemyr (NO)

(73) Assignee: JIFFY INTERNATIONAL AS, Kristiansand (NO)

(21) Appl. No.: 14/109,068

(22) Filed: Dec. 17, 2013

(51) Int. Cl. C05F 11/02; C05F 11/00; C05G 3/00; B29C 41/16

(52) U.S. Cl. CPC C05F 11/02; B29C 41/16; C05F 11/00; C05G 3/00

(57) ABSTRACT

A plant material naturally containing protection and/or sustenance compounds (hereinafter referred to as “fortification compounds”) that provide beneficial and/or improved properties when mixed with a growing medium, supporting a rooting system, is ground up and added to a substrate mix. The ground plant material may be mixed with cold or heated water and/or chemical treated to extract the organic fortification compound(s) there from. The fortified substrate mix may be used as a substrate or may be added to or compose molded or pressed horticulture materials such as plant pots, plant containers, plant trays, polyurethane plant plugs, peat bags, and plant pellets, as examples.

### BACKGROUND

1. Technical Field

The present application relates to the field of horticulture/agriculture. More specifically, effective methods for extracting compounds and/or components from organic sources are disclosed. The extracted compounds and/or components provide beneficial and/or improved properties within a growing medium such as peat and/or soil.

2. Background of the Invention

Those involved in growing plants for food, decoration or pleasure have long been aware that plants, trees, bushes, grasses and other horticultural/agricultural life require three main ingredients to maintain their health and to promote continued growth. These are sunlight, water and a fertile growing medium. The latter may be peat, soil or compost; or hydroponic substances such as wood fiber, rockwool, or coco; or substrate mixes (e.g. peat and fertilizers) in plugs, pellets and containers. In nature, as well as in cultivated fields and greenhouses, plants are maintained in a variety of complex organic growing media. In general, the roots of a plant absorb nutrients and water from the growing medium. Different types of the growing media can vary significantly in nutrient, moisture content, and other properties. While all growing media provide nutrients and moisture for the benefit of growth, they can also harbor various undesirable contaminates such pesticides, bacteria, insects, viruses and fungi. Several specific biochemicals that aid in the protection of horticultural/agricultural life have been identified. Examples include methyl salicylate (MeSA) and salicylic acid (SA). Growth media enriched with such elicitors possess beneficial qualities, such as reducing fungi growth and fighting pests and pathogens, as examples.

### BRIEF SUMMARY OF THE INVENTION

A method for extracting organic compounds from plant material includes adding ground plant material to a growing medium substrate mix such as, for example, peat with fertilizers. Examples of such plant materials include roots, blades, tissue, bark, wood, and fruit or flowers from harvested or decomposed plants or trees. In a version, the plant material naturally contains one or more variants of betulin, betulinic acid, betulinic aldehyde, betulone, betulonic acid, betulonic aldehyde, betulin-3-caffeate, lupeol, lupane, lupenone, alpha-amyrin, beta-amyrin, friedeline, oleanolic acid, oleanolic aldehyde, acetyloleanolic, erythrodiol, taraxasterol, maslinic acid, uvaol, ursane, ursolic acid, salicylate, methyl salicylate (MeSA), salicylic acid (SA), (R)-sitosterol, leucocynaidin, diethylene glycol monobutyl ether 2-(2-butoxyethoxy) ethanol, hopa-22(29)-ene 3β-ol, caryophyllene, and methyl dihydroabietate, either free or bound, covalently or non-covalently, to other organic compounds of the plant material. The plant material is ground to below 100 mm particle size and added from 0.1-100% (v/v) to a growing medium, such as a substrate mix for horticultural or agricultural purposes.

In an embodiment of the disclosure, medium ground (5 mm particle size) birch bark is added to a peat substrate mix.

In another embodiment, medium ground birch bark is added to a peat/cellulose pot mix (i.e., a mixture from which a pot, or a container, is formed). A disclosed peat pot pressing technique extracts low volatile and triterpenoid active substances from the birch bark. The peat pot pressing technique may include high temperature water evaporation and drying.

According to yet another embodiment, ground birch bark is macerated using hot water to release significant amounts of complexed bound organics like methyl salicylate (MeSA) or salicylic acid (SA), and/or release other compounds, e.g. triterpenes like betulin and betulinic acids, which then can precipitate into a peat/cellulose pot mix. Further heating may dissolve or sublimate other active lipophilic/volatile compounds from the ground birch bark during a drying process. The released compounds may include those of betulin, betulinic acid, betulinic aldehyde, betulone, betulonic acid, betulonic aldehyde, betulin-3-caffeate, lupeol, lupane, lupenone, alpha-amyrin, beta-amyrin, friedeline, oleanolic acid, oleanolic aldehyde, acetyloleanolic, erythrodiol, taraxasterol, maslinic acid, uvaol, ursane, ursolic acid, salicylate, methyl salicylate (MeSA), salicylic acid (SA), (R)-sitosterol, leucocynaidin, diethylene glycol monobutyl ether 2-(2-butoxyethoxy) ethanol, hopa-22(29)-ene 3β-ol, caryophyllene, and methyl dihydroabietate.

A method for fortifying a growing medium may include grinding birch bark to a particle size that is less than 10 millimeter (mm) and mixing the ground birch bark with water and the growing medium. The temperature of the water may be less than 30 degrees Celsius. The temperature of the mixture of ground birch bark and water may be at least 30 degrees Celsius. A ratio of the ground birch bark to a substrate comprising the growing medium may be A/B (ground birch bark/substrate), where A is within a range of 1 to 100, corresponding to B within a range of 99 to 0. The method may further include adding an organic water-miscible solvent to the water. The organic water-miscible solvent may be alcohol, as an example. In a version, the particle size may be 5 mm.

A growing medium may be fortified by grinding an organic source selected from an organic source group consisting of plants from Prunus, Citrus, Camelia, Acacia, Laurus, Magnolia, Burgeuera, Ficus, Picea, Aesculus, Larix, Quercus, Betula (all species), Aloe vera (aloe vera leaves), Amphipterygium adstringens, Arctostaphylosuva-ursi (bearberry leaves), Byrsonima crassaNiedenzu, Byrsonima crassifolia (Nance), Byrsonima fagifolia, Coffea arabica (coffee leaves), Crataegus hawthorn (leaves, flowers), Eucalyptus (eucalyptus leaves), Lavandula angustifolia (lavender leaves and flowers), Malus domestica (apples fruit peel and pomace), Mexican copal, Nerium oleander (oleander leaves), Nelumbo nucifera Gaertn, Olea europeae (olive bark, leaves, fruit and pomace), Origanum majorana (marjoram leaves), Platanus acerifolia (planes bark), Rosmarinus officinalis (rosemary leaves), Salvia officinalis (sage leaves), Sambucus nigra (black elder bark), Syzygium aromaticum (clove flower), Viscum album (mistletoe sprouts), Vitis vinifera (grape vine leaves), and Pinus sylvestris species to a particle size that is less than 10 mm, and mixing the ground organic source with water and the growing medium. The organic source may disperse at least one of betulin, betulinic acid, betulinic aldehyde, betulone, betulonic acid, betulonic aldehyde, betulin-3-caffeate, lupeol, lupane, lupenone, alpha-amyrin, beta-amyrin, friedeline, oleanolic acid, oleanolic aldehyde, acetyloleanolic, erythrodiol, taraxasterol, maslinic acid, uvaol, ursane, ursolic acid, salicylate, methyl salicylate (MeSA), salicylic acid (SA), (R)-sitosterol, leucocynaidin, diethylene glycol monobutyl ether 2-(2-butoxyethoxy) ethanol, hopa-22(29)-ene 3β-ol, caryophyllene, methyl dihydroabietate, into the growing medium. The organic source may be ground to 5 millimeter particles.

According to yet another version, a method for fortifying a growing medium may include grinding harvested or decomposed plant material selected from a group consisting of roots, blades, tissue, bark, wood, fruit and flowers that contain salicylate or triterpene compounds to a particle size within a range of 0.05 mm to 100 mm, and mixing the ground material with water and the growing medium, wherein a percentage of the ground material to the growing medium is within a range of 0.1% to 100. The ground material may be pretreated in water heated to a temperature of at least 30 degrees Celsius. The harvested or decomposed material may contain at least one of salicylates, or one of triterpenes such as betulin or betulinic acid. The particle size may be approximately 5 mm. The fortified growing medium may be mixed with a substrate mix at a ratio of approximately 20/80. The fortified growing medium may be supplied to one of a pellet handling machine and a tray filling machine.

The growing medium may be any of peat, soil or compost; or hydroponic substrates such as wood fiber, rockwool, polyurethane foam or coir/coco; or substrate mixes (e.g. peat/coir and fertilizers) in plugs, pellets, plant pots, plant trays, bags and containers; or pots/containers made of substrates.

In another version, a method for forming a fortified substrate pot may include any one or all of: screen sifting a substrate mix to produce substrate fibers; mixing the sifted substrate mix with water and pulp; adding ground birch bark to the pulp/water/substrate mix; mixing the ground birch bark/pulp/water/substrate mix to produce a slurry; pumping the slurry into a screen mold in a form of a pot; vacuuming water from the pot; drying the pot by applying heat; and pressing the dried pot. The substrate mix may include peat.

Other systems, methods, and features of the invention will be, or will become, apparent to one with skill in the art upon examination of the following figures and detailed description. It is intended that all such additional systems, methods, features and advantages be included within this description, be within the scope of the invention, and be protected by the following claims.

The preferred embodiments will now be described with reference to the attached drawings.

### BRIEF DESCRIPTION OF THE DRAWINGS

FIG. 1 is a flowchart illustrating an embodiment of a birch bark preparation method;

FIG. 2 is a flowchart illustrating an embodiment of a cold water method for extracting fortification compound(s) from ground organic material;

FIG. 3 is a flowchart illustrating an embodiment of a heat treatment method for extracting fortification compound(s) from ground organic material;

FIG. 4 is a flowchart illustrating an embodiment of a chemical treatment method for extracting fortification compound(s) from ground organic material;

FIG. 5 is a flowchart illustrating an embodiment of a water/feed preparation method;

FIG. 6 is a flowchart illustrating an embodiment of a method for fortifying horticulture supplies;

FIG. 7 is a flowchart illustrating an embodiment of a method for forming a fortified substrate pot;

FIG. 8 is a collection of pictures of peat pot samples, some of which were treated with ground birch bark; and

FIG. 9 is a picture of three peat pots, two of which were treated with ground birch bark.

### DETAILED DESCRIPTION OF THE INVENTION

The disclosure can be better understood with reference to the following drawings and description. The components in the figures are not necessarily to scale, emphasis instead being placed upon illustrating the principles of the invention. Moreover, in the figures, like referenced numerals designate corresponding parts or elements throughout the different views.

In the following description the terms “growing medium” and “growing media” refer to any media that contains, e.g. physical support, air space, buffer and cation exchange capacity, nutrients and moisture for absorption by the root system of organic life such as plants, trees, bushes, grasses and other horticultural/agricultural life. “Growing medium” and “growing media” may also refer to peat, soil or compost; or hydroponic substrates such as wood fiber, rockwool, polyurethane foam or coir/coco; or substrate mixes (e.g. peat/coir and fertilizers) in plugs, pellets, plant pots, plant trays, bags and containers; or pots/containers made of substrates. It is to be understood that while particular reference is made throughout the specification to “substrate mix”, “peat mix,” and “horticultural mix” it is to be understood that such reference also includes generally any growing medium, or combinations thereof.

The present invention is directed at providing at least one of beneficial and/or improved properties within a growing medium such as peat and/or coco/coir. The beneficial and/or improved properties may include one or more of anti-fungal properties, anti-bacterial properties, anti-virus properties, increased germination and rooting in pots and substrates for seedlings, providing protection against pests and/or insects, combating adverse growing conditions, enduring harsh environmental regimes (e.g., high heat and/or drought conditions), combating stress caused by salinity and/or injury, and generally increasing plant biomass.

A plant material naturally containing protection and/or sustenance compounds (hereinafter referred to as “fortification compounds”) that provides beneficial and/or improved properties to a growing medium, supporting a rooting system, is ground up and added to a substrate mix. The ground plant material may be mixed with cold/tepid water and the mixture is added to the substrate mix (“cold water technique”). The ground plant material may be heated in a solvent such as water for extracting the fortification compound(s) (“heat treatment technique”) and the mixture is added to a substrate mix. In yet another version, more organic water-miscible solvents, such as alcohol like ethanol, or lipophilic compounds like wax or oils, may be added as a solvent (“chemical treatment technique”) for organics in the plant material in the ‘heat’ treatment technique, and the resultant mixture added to a substrate mix. Further, the substrate mix may be added to or compose the horticulture materials used to make/form peat/cellulose pots, peat/coco containers, loosed-filled peat/coco mixes in trays, polyurethane peat/coco plugs, peat or coco bags or pellets, as examples, or any other growing media.

In another version, the ground plant material is mixed with cold or heated water that may, or may not, include an organic water-miscible solvent, and the resultant mix may be used to directly “water” plant or tree life.

One example of a plant material that includes fortification compounds is birch bark. Other examples are plants and trees from the Prunus, Citrus, Camelia, Acacia, Laurus, Magnolia, Burgeuera, Ficus, Picea, Aesculus, Larix, Quercus, Betula (all species), Aloe vera (aloe vera leaves), Amphipterygium adstringens, Arctostaphylosuva-ursi (bearberry leaves), Byrsonima crassa Niedenzu, Byrsonima crassifolia (Nance), Byrsonima fagifolia, Coffea arabica (coffee leaves), Crataegus hawthorn (leaves, flowers), Eucalyptus (eucalyptus leaves), Lavandula angustifolia (lavender leaves and flowers), Malus domestica (apples fruit peel and pomace), Mexican copal, Nerium oleander (oleander leaves), Nelumbo nucifera Gaertn, Olea europeae (olive bark, leaves, fruit and pomace), Origanum majorana (marjoram leaves), Platanus acerifolia (planes bark), Rosmarinus officinalis (rosemary leaves), Salvia officinalis (sage leaves), Sambucus nigra (black elder bark), Syzygium aromaticum (clove flower), Viscum album (mistletoe sprouts), Vitis vinifera (grape vine leaves), and Pinus sylvestris species. Fortification compounds include one or more of betulin, betulinic acid, betulinic aldehyde, betulone, betulonic acid, betulonic aldehyde, betulin-3-caffeate, lupeol, lupane, lupenone, alpha-amyrin, beta-amyrin, friedeline, taraxasterol, oleanolic acid, oleanolic aldehyde, acetyloleanolic, erythrodiol, maslinic acid, uvaol, ursane, ursolic acid, salicylate, methyl salicylate (MeSA), salicylic acid (SA), (R)-sitosterol, leucocynaidin, diethylene glycol monobutyl ether 2-(2-butoxyethoxy) ethanol, hopa-22(29)-ene 3β-ol, caryophyllene, and methyl dihydroabietate, either free or linked to other organic compounds within the plant.

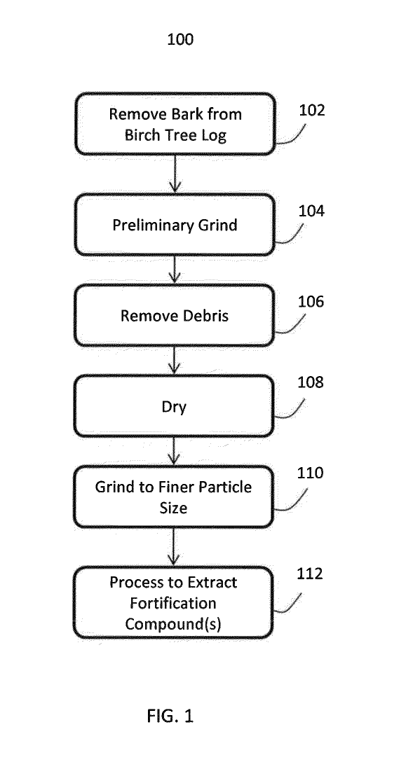

Referring now to FIG. 1, an embodiment of a birch bark preparation method is shown. The method 100 includes removing (through stripping or scalping or other process) bark from a birch tree log (102) and preliminarily grinding the removed birch bark (104). The birch bark may be preliminarily ground by a hammer mill to approximately 100 mm particle size, as an example. Preferably, the hammer milling process removes unwanted debris from the preliminarily ground birch bark (106). The preliminarily ground birch bark may then be dried (108). The birch bark may be dried in an oven, as an example. The dried, ground birch bark is then ground further (110), preferably to approximately 5 millimeter sized particles, providing birch bark grind. A cutting mill with a ⅛^{th} inch screen may be used in the final grinding step. In other versions, the dried, ground birch bark may be ground to particles sized less than 1.0 mm. For example, the final grind may provide 0.05 mm birch bark particles. The size of the birch bark particles is determined by the grade of mesh, which is preferably 18 grade. Eighteen grade mesh provides a grind mixture having approximately 48% ground birch bark by weight. Preferably, the final grind provides birch bark particles of a size in the range of 0.05 mm to 100 mm. The ground birch bark is further processed (112) to extract fortification compound(s) there from, in accord with one or more of the techniques discussed below.

In other embodiments, a plant material other than birch bark is processed according to the preparation method. Other plant materials include roots, blades, tissue, bark, wood, and fruit or flowers harvested or decomposed from plants or trees from the Prunus, Citrus, Camelia, Acacia, Laurus, Magnolia, Burgeuera, Ficus, Picea, Aesculus, Larix, Quercus, Betula (all species), Aloe vera (aloe vera leaves), Amphipterygium adstringens, Arctostaphylosuva-ursi (bearberry leaves), Byrsonima crassaNiedenzu, Byrsonima crassifolia (Nance), Byrsonima fagifolia, Coffea arabica (coffee leaves), Crataegus hawthorn (leaves, flowers), Eucalyptus (eucalyptus leaves), Lavandula angustifolia (lavender leaves and flowers), Malus domestica (apples fruit peel and pomace), Mexican copa^{I}, Nerium oleander (oleander leaves), Nelumbo nucifera Gaertn, Olea europeae (olive bark, leaves, fruit and pomace), Origanum majorana (marjoram leaves), Platanus acerifolia (planes bark), Rosmarinus officinalis (rosemary leaves), Salvia officinalis (sage leaves), Sambucus nigra (black elder bark), Syzygium aromaticum (clove flower), Viscum album (mistletoe sprouts), Vitis vinifera (grape vine leaves), and Pinus sylvestris species.

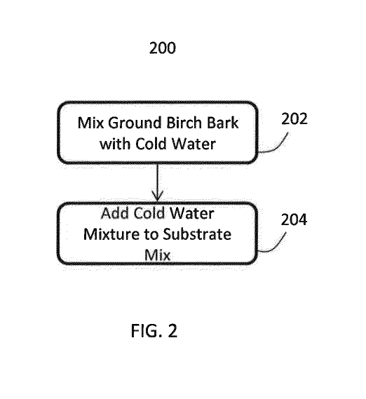

Referring to FIG. 2, an embodiment of a cold water method 200 is shown. By way of example, ground birch bark resulting from a birch bark preparation method is mixed with cold water (202), providing a heterogeneous mixture of ground birch bark and cold water. In a version, “cold water” refers to water temperature of 30 degrees Celsius or lower. The cold water mixture is added to a substrate mix (204). In one version, the substrate mix contains approximately 15% ground birch bark by volume. In another version, only ground birch bark is used (i.e., the amount of ground birch bark is 100%). It is to be understood that the percentage by volume of ground birch bark to substrate mix may be a percentage within the range of 0.1 to 100%.

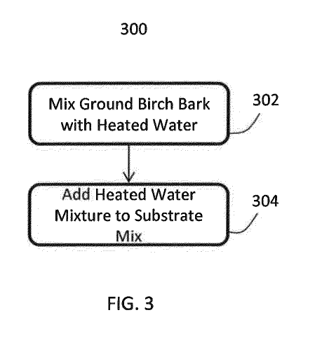

Referring to FIG. 3, an embodiment of a heat treatment method 300 for extracting the fortification compound(s) from the ground plant material is shown. By way of example, ground birch bark resulting from the birch bark preparation method is mixed with heated water (302), providing a heterogeneous mixture of ground birch bark and heated water. As an example, one tablespoon of ground birch bark may be added to one gallon of heated water. In one version, the ground birch bark is added to water heated to 100 degrees Celsius. The heated mixture is added to a substrate mix (304). The heat treatment technique 300 extracts fortification compounds, including water soluble organics like triterpenes (e.g. betulinic acids) and salicylates from the ground birch bark which disperse into the substrate mix. It is noted that the mixture may be heated to any temperature sufficient to release salicylate or other fortification compound(s) from the ground birch bark.

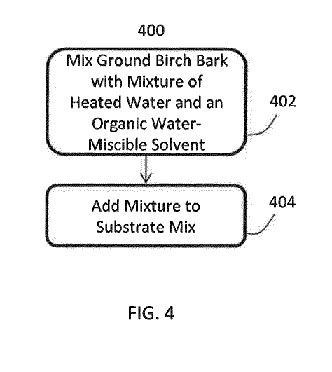

Referring to FIG. 4, an embodiment of a chemical treatment method 400 for extracting the fortification compound(s) from the ground plant material is shown. By way of example, ground birch bark resulting from the birch bark preparation method is heated in water and a more organic water-miscible solvent (402). Examples of organic water-miscible solvents include alcohol, wax emulsions, and some ethers. The heated chemical mixture is added to a substrate mix (404), providing a heterogeneous mixture. The chemical treatment technique 400 extracts fortification compounds from the ground birch bark, including betulin and methyl salicylate, which disperse into the substrate mix.

In the heat and chemical treatment methods, as in the cold treatment method, the substrate mix may contain 0.1% ground birch bark, only ground birch bark, or a percentage of ground birch bark to substrate mix within the range of 0.1 to 100%.

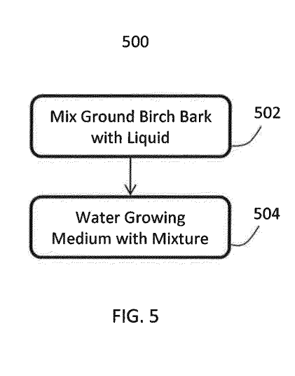

Referring to FIG. 5, an embodiment of a water/feed preparation method 500 is shown for preparing a fortified water feed mixture from the ground plant material obtained by way of, for example, the method of FIG. 1. By way of example, ground birch bark resulting from a birch bark preparation method is mixed (to provide a heterogeneous mixture) with a liquid (502) such as cold water, heated water, or a mixture of heated water and an organic water-miscible solvent. The fortified water is then used to water the growing medium supporting plant or tree life (504).

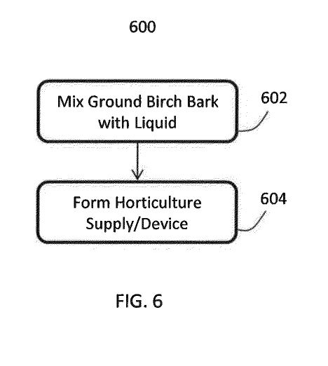

Referring to FIG. 6, an embodiment of a method for fortifying horticulture supplies (600) is shown. By way of example, ground birch bark resulting from a birch bark preparation method is mixed (to provide a heterogeneous mixture) with a liquid (602) such as cold water, heated water, or a mixture of heated water and an organic water-miscible solvent. In a preferred version, the birch bark is ground with an 18 mesh screen to approximately 5 mm particle size. The mixture may then be used to form a horticulture supply/device (604) such as a peat/coco pot, plant container, loose-filled peat or coco in a tray, polyurethane coco or peat plug, peat or coco bag or pellet, as examples. In an alternate embodiment, the mixture is added to a substrate mix, and the mixture is used to form a horticulture supply/device. The ratio of ground birch bark mixture to substrate mix may be anywhere within the range of 1 to 100 percent, depending upon any number of factors such as cost, recommended application, and purpose (e.g., protection against pests, fungi, insects, bacteria, and/or viruses, to promote rooting and germination, producing a higher yield of plant biomass, combating adverse growing conditions, enduring harsh environmental regimes (e.g., high heat and/or drought conditions), and combating stress caused by salinity and/or injury).

As discussed above, ground plant material, for example birch bark ground according to the method discussed above with reference to FIG. 1, may be used to fortify a peat pot. Examples of apparatuses and methods for forming peat pots are disclosed in U.S. Pat. No. 2,922,476 (Apparatus for Producing Hollow Articles by Dewatering Fiber Pulp, issued Jan. 26, 1960) to Koxvold, hereby incorporated herein by reference in its entirety.

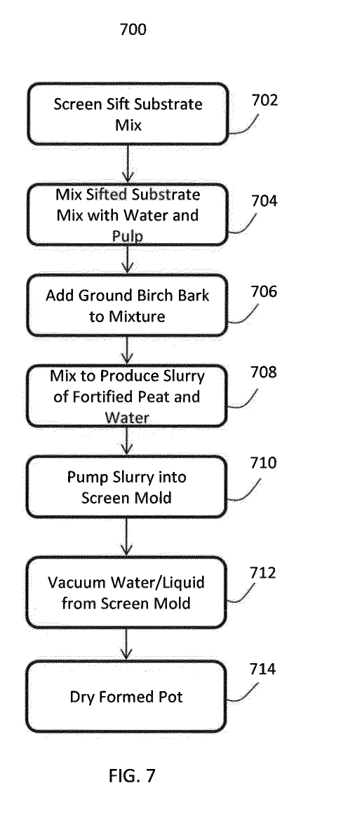

FIG. 7 is a flowchart illustrating an embodiment of a method 700 for forming a fortified substrate pot. Peat, or other substrate mix, is screen sifted to produce peat fibers. As examples, an 8 grade mesh provides between approximately 8% to 12% peat fiber by weight, an 8/70 grade combination mesh provides between approximately 88% to 92% peat fiber by weight, and a 70 grade mesh provides between approximately 0.5% to 2.5% peat fiber by weight (702). The peat is mixed with water and pulp (704). Ground birch bark is added to the peat/water/pulp mix (706). In a preferred version, the birch bark is ground to at or below 5 mm particles. The ground birch bark is added to the peat/water/pulp mixture to obtain a slurry having, in one version, approximately 15% ground birch bark by total volume. In another version, ground birch bark is added to obtain a slurry having a ratio of 55/45 of peat to pulp by weight. The slurry may be mixed together for a desired duration. For example, the slurry may be mixed for approximately fourteen minutes before further processing. The slurry may then be pumped into a screen mold in the desired form of a pot (710). A vacuum removes water from the formed pot (712). In a version, the formed pot is then dried in an oven (714). In a preferred version, a formed pot is dried by pre-heating an oven to 50 degrees Celsius, inserting the pot in the oven and allowing the temperature to increase to approximately 300 degrees Celsius over an 8 minute period, and gradually decreasing the temperature back to 50 degrees Celsius as the moisture is removed from the pot over a 20 minute period. In other versions, the formed pot is dried at higher temperatures for longer periods to increase the hydrophobic properties of the pot. It is noted that hydrophobic degree or amount is proportional to the drying temperature and/or drying time. In an alternate embodiment, the fortified peat pot may be formed in accord with the apparatuses and methods disclosed in the Koxvold patent, wherein the fiber pulp used to form the pot is fortified with ground birch bark prior to forming the pot. Heating ground birch bark in water releases compounds like salicylates, or methyl salicylate, and heating dried ground birch at temperatures above 180-200° C. sublimates triterpenes, such as betulin. Salicylates are often complex bound to a sugar chains in bark via ester links, and by hot water maceration, it is released from bark into the peat mix. Triterpenes are mostly hydrophobic and water insoluble substance in the bark, but may be able to sublimate from bark at elevated temperatures.

### Test Results

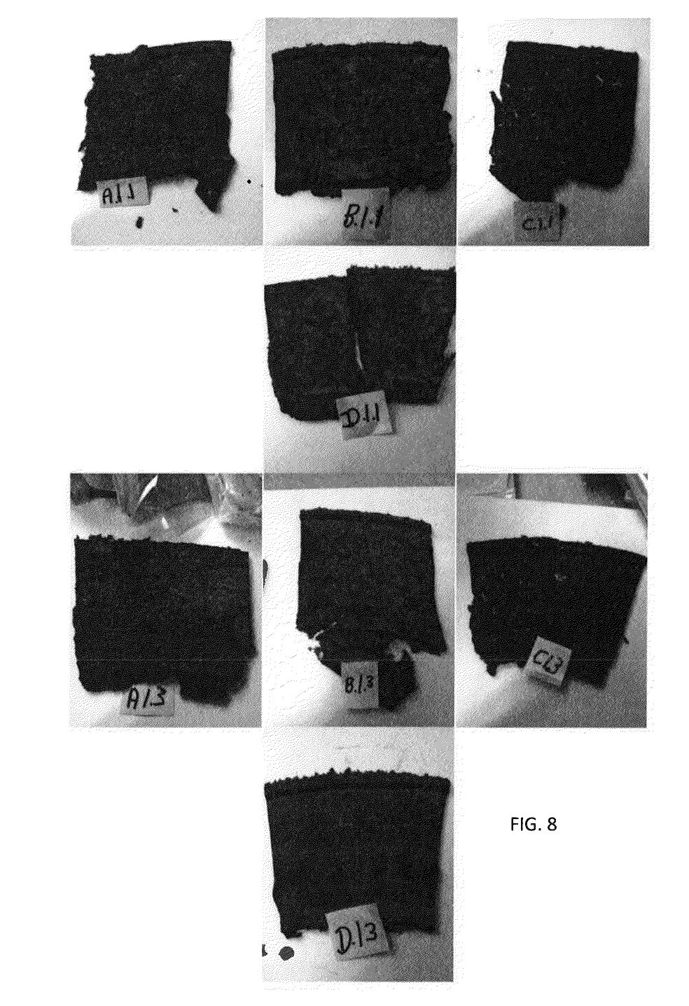

Pots formed, using a heat treatment method, from substrate mixes both with and without ground birch fortification were tested for mold growth. In FIG. 8, samples C.1.1 and C.1.3 were formed from substrate mixes having 15% ground birch bark. FIG. 8 shows that the samples (C.1.1 and C.1.3) that contain ground birch bark show no mold growth as opposed to the samples that do not contain ground birch bark (A.1.1, A.1.3, B.1.1, B.1.3, D.1.1, and D.1.3).

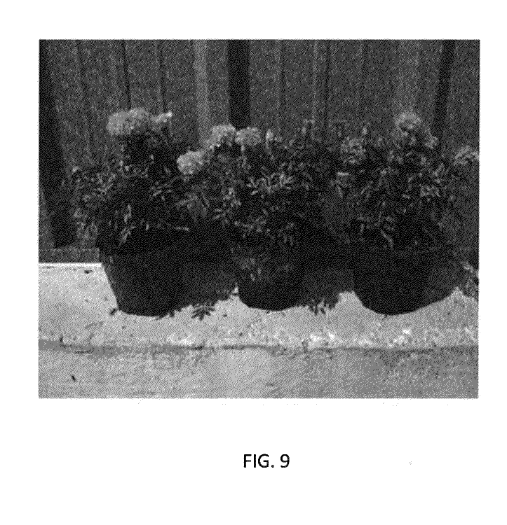

FIG. 9 shows three pots in which small plant plugs of Marigolds were planted. The pot on the left was formed with ground birch bark and a standard (untreated) substrate, and the pot on the right is a standard pot filled with ground birch bark treated substrate mix and irrigated with heated ground birch bark enriched water. The pot in the middle is a standard untreated pot and standard substrate. The pots on the left and right experienced no mold growth, while the untreated pot in the middle shows significant mold growth. All three plants were grown outside in normal summer conditions.

It is intended that the foregoing detailed description be understood as an illustration of selected forms that the invention can take and not as a definition of the invention. It is only the following claims, including all equivalents, that are intended to define the scope of this invention.

We claim:

1. A method for fortifying a growing medium, the method comprising:
grinding birch (Betula) bark to a particle size that is less than 10 millimeter (mm); and
mixing the ground birch bark with water and the growing medium.

2. The method of claim 1 wherein the water is less than 30 degrees Celsius.

3. The method of claim 1 wherein a temperature of a mixture of the ground birch bark and water is at least 30 degrees Celsius.

4. The method of claim 1 wherein a ratio of the ground birch bark to a substrate comprising the growing medium is A/B (ground birch bark/substrate), wherein A is within a range of 1 to 100, corresponding to B within a range of 99 to 0.

5. The method of claim 1 further comprising adding an organic water-miscible solvent to the water.

6. The method of claim 5 wherein the organic water-miscible solvent is alcohol.

7. The method of claim 1 wherein the particle size is 5 mm.

8. The method of claim 1 wherein the growing medium is one of a peat, soil or compost; or hydroponic substrates such as wood fiber, rockwool, polyurethane foam or coir/coco; or substrate mixes (e.g. peat/coir and fertilizers) in plugs, pellets, plant pots, plant trays, bags and containers; or pots/containers made of substrates.

9. A method for fortifying a growing medium, the method comprising:
grinding a fortification compound selected from a fortification compound group consisting of plants from Prunus, Citrus, Camelia, Acacia, Laurus, Magnolia, Burgeuera, Ficus, Picea, Aesculus, Larix, Quercus, Betula (all species), Aloe vera (aloe vera leaves), Arctostaphylosuva-ursi (bearberry leaves), Eucalyptus (eucalyptus leaves), Lavandula angustifolia (lavender leaves and flowers), Malus domestica (apples fruit peel and pomace), Nerium oleander (oleander leaves), Olea europeae (olive bark, leaves, fruit and pomace), Origanum majorana (marjoram leaves), Platanus acerifolia (planes bark), Rosmarinus officinalis (rosemary leaves), Salvia officinalis (sage leaves), Syzygium aromaticum (clove flower), Viscum album (mistletoe sprouts) and Pinus sylvestris species, to a particle size that is less than 10 mm; and
mixing the ground fortification compound with water and the growing medium.

10. The method of claim 9 wherein the fortification compound disperses at least one of triterpene/triterpenoids like betulin, betulinic acid, betulinic aldehyde, betulone, betulonic acid, betulonic aldehyde, betulin-3-caffeate, friedeline, lupeol, taraxasterol lupenone, oleanolic acid, and oleanic aldehyde, or other compounds like salicylate, methyl salicylate, and salicylic acid into the growing medium.

11. The method of claim 9 wherein the fortification compound is ground to 5 millimeter particles.

12. The method of claim 9 wherein the growing medium is one of peat, soil or compost; or hydroponic substrates such as wood fiber, rockwool, polyurethane foam or coir/coco; or substrate mixes (e.g. peat/coir and fertilizers) in plugs, pellets, plant pots, plant trays, bags and containers; or pots/containers made of substrates.

13. A method for fortifying a growing medium, the method comprising:
grinding a harvested or decomposed plant material selected from a group consisting of roots, blades, tissue, bark, wood, fruit and flowers that contain salicylate or triterpene/triterpenoid compounds to a particle size within a range of 0.05 mm to 100 mm;
mixing the ground material with water and the growing medium, wherein a percentage of the ground material to the growing medium is within a range of 0.1% to 100.

14. The method of claim 13 wherein ground material is pretreated in water heated to a temperature of at least 30 degree Celsius.

15. The method of claim 13 wherein the harvested or decomposed material contains at least one of triterpene/triterpenoids like betulin, betulinic acid, betulinic aldehyde, betulone, betulonic acid, betulonic aldehyde, betulin-3-caffeate, friedeline, lupeol, taraxasterol lupenone, oleanolic acid, and oleanic aldehyde, or other compounds like salicylate, methyl salicylate, and salicylic acid into the growing medium.

16. The method of claim 13 wherein the growing medium is one of a peat, soil or compost; or hydroponic substrates such as wood fiber, rockwool, polyurethane foam or coir/coco; or substrate mixes (e.g. peat/coir and fertilizers) in plugs, pellets, plant pots, plant trays, bags and containers; or pots/containers made of substrates.

17. The method of claim 13 wherein the particle size is approximately 5 mm.

18. The method of claim 13 further comprising mixing the fortified growing medium with a substrate mix at a ratio of approximately 20/80.

19. The method of claim 13 further comprising supplying the fortified growing medium to one of a pellet handling machine and a tray filling machine.

20. A method for forming a fortified substrate pot, the method comprising:
screen sifting a substrate mix produce substrate fibers;
mixing the sifted substrate mix with water and pulp;
adding ground birch bark to the pulp/water/substrate mix
mixing the ground birch bark/pulp/water/substrate mix to produce a slurry;
pumping the slurry into a screen mold in a form of a pot
vacuuming water from the pot; and
drying the pot by applying heat.

21. The method of claim 20 wherein the substrate mix is peat.

22. The method of claim 20 further comprising pressing the dried pot.
